(19) United States
(12) Patent Application Publication
(10) Pub. No.: US 2015/0289704 A1
(43) Pub. Date: Oct. 15, 2015

(54) DISPENSER FOR MEASURED DOSES OF LIQUID AND METHOD OF USING

(71) Applicant: Aircom Manufacturing, Inc., Indianapolis, IN (US)

(72) Inventors: John Hengesbach, Carmel, IN (US); Marc Christie, Indianapolis, IN (US); Gregory A. Lyon, Indianapolis, IN (US)

(21) Appl. No.: 14/686,625

(22) Filed: Apr. 14, 2015

Related U.S. Application Data
(60) Provisional application No. 61/979,891, filed on Apr. 15, 2014.

(51) Int. Cl. A47J 31/40; B05B 11/00

(52) U.S. Cl. CPC A47J 31/402; B05B 11/3023; B05B 11/3045; A47J 31/407

(57) ABSTRACT

A dispenser which has parts that can be removed, cleaned or disposed of when changing supply containers such that the supply containers can be quickly changed while maintaining sanitary conditions. The dispenser has a piston pump in which the piston has a permanent part and a removable end piece. The end piece is configured to contact the liquid during movement of the piston in a cylinder, but the remainder of the piston and other hardware does not contact the liquid. The end piece of the piston can thus be discarded and replaced or cleaned each time the supply of liquid is changed. The nozzle assembly is also removable and cleanable or replaceable. The nozzle assembly can be replaced with an identical one or a different nozzle assembly suitable for dispensing a different liquid. Also disclosed is a portable housing for the supply containers that has a pivotable floor panel.

### RELATED APPLICATIONS

This application claims priority to U.S. Provisional Patent Application Ser. No. 61/979,891, filed Apr. 15, 2014, which is incorporated herein by reference in its entirety.

### BACKGROUND

The present invention relates to a dispensing device, and more particularly, to a dispenser for reliably and accurately dispensing predetermined doses of a liquid. The present invention also relates to a method of using a dispenser.

In the food service industry, in particular, in environments in which workers must prepare customized beverages such as lattes, cappuccinos and the like, it is of paramount importance that the dispensing of such liquids be accurate, reliable and fast. For example, in the modern coffee house, the so-called “baristas” often encounter a steady stream 10-20 or more people waiting in line to have their custom coffee drink prepared. For the barista to provide timely service, he or she must be able to prepare each customized drink quickly and efficiently, yet still maintain the level of consistency and quality in each beverage to which the customers have become accustomed.

One component that is added to a large number of beverages is cream, which is required in many coffee drinks in specified amounts to ensure the consistency and quality of the beverage. Different types of automatic dispensing devices that provide measured amounts of cream are known.

One type of cream dispenser is commonly referred to by those of skill in the art as “gravity feed.” In a gravity feed dispenser, a container or bag of liquid has an outlet tube or nozzle which includes a pinch valve or similar valve which can be controlled electronically or mechanically. One disadvantage of a gravity feed system is that the flow rate can vary as a function of the head height, meaning that as the amount of liquid in the container decreases with use, the flow rate also decreases, which in turn makes accurately and reliably providing the desired dose problematic. Another disadvantage with a typical gravity feed arrangement is that it is difficult to obtain complete emptying of the supply container, thereby resulting in wasted product.

Another type of dispenser used for cream utilizes a peristaltic pump. A peristaltic pump is a type of positive displacement pump used for pumping liquid in which the fluid is contained within a flexible tube fitted inside a circular pump casing. A rotor with a number of rollers or shoes attached to its external circumference compresses the flexible tube. As the rotor turns, the part of the tube under compression is pinched or closed, thus forcing the fluid to be pumped through the tube. The size of the dose to be dispensed in a dispenser using a peristaltic pump depends on the spacing of the rollers. The smaller the spacing, the smaller the dose. One difficulty with a peristaltic pump for use in a dispenser is that the speed with which the rotor can be spun is limited and, accordingly, the flow rate is limited. Furthermore, the inherent spinning of the rotor produces some limitations in the accuracy with which a dose of liquid can be metered. Furthermore, clogging can pose an issue with a peristaltic pump.

Another problem with known liquid dispensers is the ability to quickly switch supply containers when the existing container is empty yet still maintain a clean and sanitary environment. As noted above, in some environments, e.g., coffee houses, the barista may have a line of several waiting customers. Thus, if the barista has to change supply containers when he or she is already busy servicing customers, the time necessary to switch supplies and perform the requisite clean-up produces an interruption in service. This is obviously undesirable since it is well understood that frequent patrons of coffee houses and similar establishments expect fast service.

Yet it is critically important in these busy environments such as coffee houses that the workplace be maintained clean and sanitary. Further, there are commercial standards dictating adequate sanitation, e.g., NSF 20, which establishes minimum food protection and sanitation requirements for the materials, design, construction, and performance of commercial bulk milk dispensers and their related components. Notwithstanding the obvious importance of maintaining a sanitary environment, changing from an empty cream container to a new one in a liquid dispenser, for example, can be fraught with sanitation issues. For example, parts of the dispenser which contact cream can be in some cases difficult to access, thereby leaving residual cream in the dispenser, which may spoil or otherwise become unsanitary. Furthermore, it is often time-consuming to perform even a marginal wipe-down of the equipment during a busy time when customers are waiting. This raises the likelihood that the barista will switch the containers too quickly, without proper attention to cleaning the dispenser parts. A busy and unsupervised barista may even entirely skip the necessary cleaning steps in favor of saving time to more quickly attend to the customers waiting in line.

A related shortcoming of existing dispensers is that they are often only able to accurately dispense one type of fluid, whether it be cream, ketchup, yogurt, smoothie, etc. Attempting to dispense a smoothie product with a cream dispenser, for example, may cause the dispenser to dispense inaccurately, clog, or not work at all. As a result, a separate dispenser must be provided for each different liquid that is to be automatically dispensed. This, in turn, requires extra counter space in a typically crowded environment where space is already at a premium. Further, each additional dispenser requires an additional capital investment in equipment with the concomitant maintenance time and expense.

What is needed, then, is a dispenser that can be used in circumstances such as those described above that provides a consistently accurate dose of liquid, quickly, and for which supply containers can be quickly switched while largely avoiding sanitation issues. Further, it would be desirable to eliminate the need for multiple dispensers for different liquids wherever possible, yet still maintain the ability to dispense accurate doses of different liquids.

### SUMMARY

The present invention provides an inventive dispenser assembly which has parts that can be removed, cleaned or discarded and replaced when changing supply containers such that the supply containers can be quickly changed while maintaining sanitary conditions. The present invention also provides a dispenser that accommodates modular use for different liquids. By employing one or more interchangeable parts, the dispenser can be quickly reconfigured on site to adapt to different liquids having different viscosities and different fluid properties.

In one form, this disclosure teaches a liquid dispenser. The dispenser has a main cylinder having a piston disposed therein, an inlet fluidly connected to the main cylinder for entry of liquid into the cylinder, and an outlet fluidly connected to the cylinder for dispensing a measured amount of liquid. An entry valve is disposed about the inlet and is configured to allow liquid to enter the cylinder but not exit, and an exit valve is disposed about the outlet and is configured to allow liquid to exit the cylinder but not enter. The piston has a permanent part and an end piece removably connected thereto. The end piece is configured to contact the liquid during movement of the piston in the cylinder, but the remainder of the piston and other hardware does not contact the liquid. The removable end piece can be configured with a snap fit connection or a bayonet style connection, to name just a few alternatives.

In another embodiment, a nozzle assembly includes the main cylinder body in which the piston reciprocates to draw in and dispense liquid. The nozzle assembly further includes an inlet and an outlet extending from and fluidly connected to the main cylinder body, the inlet and outlet each including a one-way valve. According to one embodiment of this disclosure, the entire nozzle assembly is removable from the dispenser and the container, and it can be washed or disposed of and replaced with a new one. This feature advantageously improves the ease with which an empty container can be quickly replaced with a new one while maintaining sanitary conditions. Specifically, the parts that contact the liquid and that might thus raise sanitation issues can be quickly discarded and replaced with new ones. This saves time and labor in the busy workplace in which the dispenser can be used.

In another form thereof, this disclosure teaches a method of operating a liquid dispensing apparatus of the type described above, i.e., having a piston pump and a nozzle assembly, the nozzle assembly having a main cylinder body within which a piston of the piston pump reciprocates and an inlet tube and an outlet tube fluidly connected to the main cylinder body. As described above, the inlet tube has an entry valve configured to allow liquid to enter the main cylinder body but not exit, and the outlet tube has an exit valve configured to allow liquid to exit the main cylinder body but not enter. The method comprises connecting a container having a supply of liquid to the inlet tube. The piston pump is used to dispense measured doses of the liquid until the container is substantially empty or until it is desired to change liquid supplies. The container is then disconnected from the dispenser and a new container with a fresh supply of the same or different liquid is connected. Further, before connecting the new container, at least one of the following steps are performed: (i) disconnecting a removable end piece from a permanent part of the piston; and (ii) replacing the nozzle assembly, the replacement nozzle assembly differing from the one being replaced in at least one of the following parameters: opening pressure of one of the valves, size of the inlet tube, and connection fitting of the inlet tube.

As just noted, the nozzle assembly can be replaced with a differently configured nozzle assembly. This may be the case, for example, when it is desired to change the dispenser to a different liquid to be dispensed.

In exemplary embodiments, the method includes cleaning the end piece after it is removed and then re-connecting it to the permanent part of the piston. Alternatively, the end piece can be discarded and a new end piece can be connected to the permanent part of the piston for use with the new supply of liquid. Similarly, the nozzle assembly can be configured as removable and disposable, as noted above. Thus, the end piece and nozzle assembly can be discarded together, discarded separately, or one or both can be cleaned and then used again. All of these variations provide a method in which the changing to a new supply container with the same or different liquid can be simple and fast while easily maintaining sanitary conditions.

In another embodiment, the liquid dispenser is provided with a housing or “caddy.” The housing is adapted to house a flexible supply container from which liquid is to be dispensed. The housing includes one or more side walls and a movable floor panel adapted to support the container of liquid. The movable floor panel is pivotable between a first position at which the movable floor panel is positioned at a decline with respect to horizontal and a second position at which the movable floor panel is positioned at an incline with respect to horizontal. A spring is connected to the movable floor panel and biases the movable floor panel toward the inclined position. The spring has a spring force such that the movable floor panel pivots toward the second or fully inclined position as the container becomes lighter from liquid being dispensed.

### BRIEF DESCRIPTION OF THE DRAWINGS

The above-mentioned aspects of this disclosure and the manner of obtaining them will become more apparent and this disclosure itself will be better understood by reference to the following description of exemplary embodiments, taken in conjunction with the accompanying drawings, wherein:

FIG. 1 is a perspective view of a liquid dispensing apparatus in accordance with this disclosure;

FIG. 2 is an exploded perspective view of the liquid dispensing apparatus shown in FIG. 1;

FIGS. 3A and 3B are fragmentary end views in partial cross-section depicting a cylinder, removable piston end piece and a permanent part of a piston in accordance with a dispenser of this disclosure;

FIG. 4A is a fragmentary view of the removable piston end piece, cylinder, and one-way valves during entry of liquid into the cylinder;

FIG. 4B is a fragmentary view of the removable piston end piece, cylinder, and one-way valves during dispensing of liquid from the cylinder;

FIGS. 4C and 4D are side sectional views of an embodiment of a one-way valve for use in the piston and cylinder arrangement of FIGS. 4A and 4B.

FIGS. 5A-5D depict a sequence of process steps for using a dispensing apparatus in accordance with this disclosure; and

FIGS. 6A-6B are perspective views with portions removed or shown in phantom of a housing that can accommodate a supply container of liquid.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

In this disclosure, terms such as “vertical,” “parallel,” “horizontal,” “right angle,” “rectangular” and the like are used to describe the orientation, position or general shape of structural elements disclosed herein. As would be readily recognized by one of ordinary skill, it shall be understood for purposes of this disclosure and claims that these terms are not used to connote exact mathematical orientations or geometries, unless explicitly stated, but are instead used as terms of approximation. With this understanding, the term “vertical,” for example, certainly includes a structure that is positioned exactly 90 degrees from horizontal, but should generally be understood as meaning positioned up and down rather than side to side. Other terms used herein to connote orientation, position or shape should be similarly interpreted. Further, it should be understood that various structural terms used throughout this disclosure and claims should not receive a singular interpretation unless it is made explicit herein.

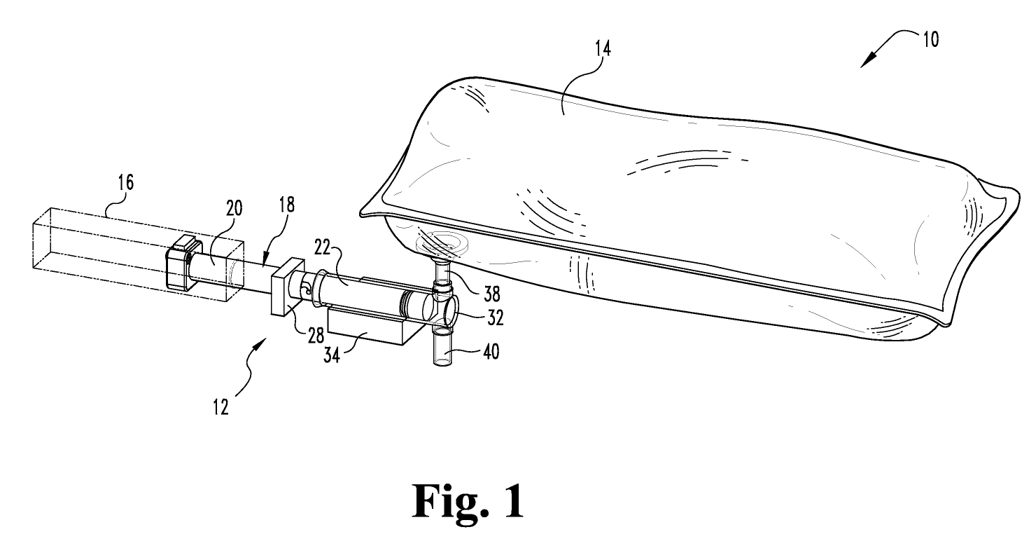

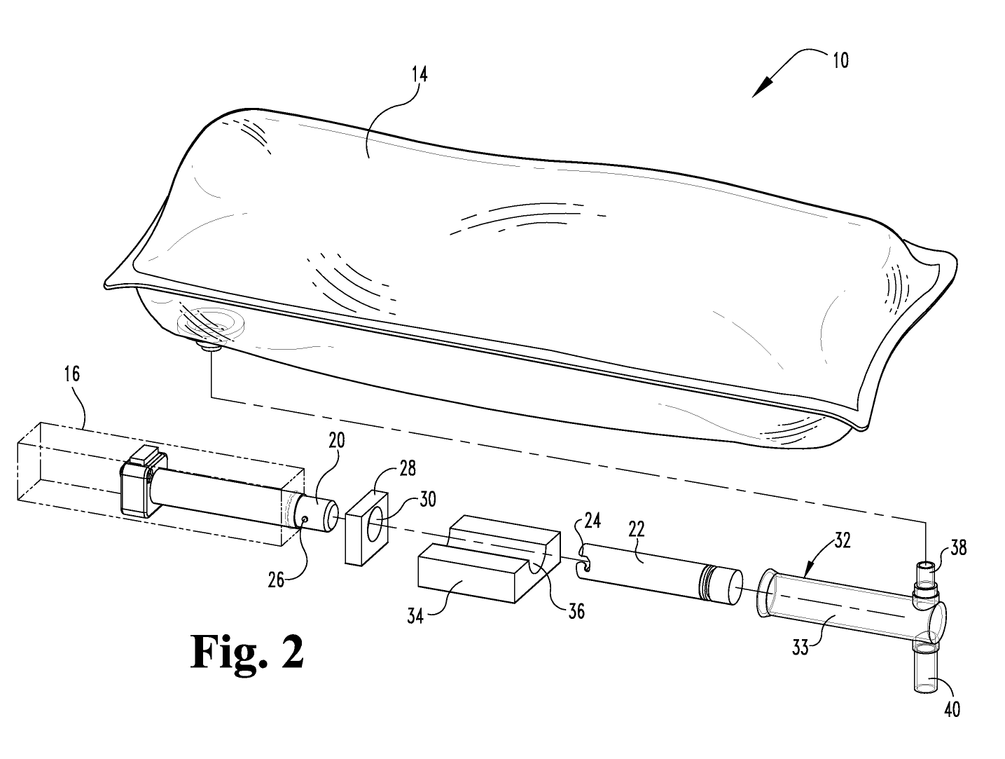

Turning now to FIGS. 1 and 2, the dispensing apparatus 10 includes a piston pump assembly 12 and a liquid supply container 14 which can hold a liquid such as cream and which can be removably connected to the piston pump assembly 12 in a substantially air-tight manner. As depicted in FIGS. 1 and 2, the container is provided in the form of a flexible and collapsible bag, preferably made from plastic, although this is not necessary. The container may instead be formed of other materials, e.g., foils, flexible papers, and may also be semi-flexible or even rigid or substantially rigid. One advantage of a collapsible container, however, is that it becomes smaller in size as the liquid is dispensed such that when it is time to replace the container, which can be disposable or recyclable, the container takes up a minimum of space. In one embodiment, the flexible bag-type containers contemplated are somewhat standardized in the service industry in which they are used and the piston pump dispensing apparatus is intended to be compatible therewith.

As shown in FIGS. 1 and 2, container 14 is removably and detachably connected to piston pump assembly 12, which is shown in exploded form in FIG. 2. The piston pump assembly 12 includes a housing 16 configured to hold a motor, e.g., stepper motor, or other mechanical apparatus that can advance the piston 18 by a precisely controlled distance. By way of example, a stepper motor can be employed to accurately control the linear distance it is desired to move the piston. As is known in the art, a stepper motor is typically a brushless DC electrical motor that divides a full rotation into a number of equal steps. The motor's position can then be commanded to move and hold at one of these steps without any feedback sensor as long as the motor is carefully sized to the application.

A stepper motor has been found to be particularly suitable with the dispenser of the present disclosure due to its high accuracy. It has been found that accuracy of less than 1% error can be obtained, for example, in dispensing a 100 ml dose of liquid using a stepper motor to power the piston. This high accuracy results from the fine incremental step size of the motor. This is to say that a selected dose of 100 ml can actually be within +/−0.5 ml of the target using a dispenser in accordance with this disclosure. An example of a commercially available stepper motor suitable with a dispenser in accordance with this disclosure is a Model E43M4Y-2.33-A01 available from Hayden Kerk. It should be understood, however, that other mechanical and electro-mechanical means known in the art could be employed to accurately control the movement of the piston. It is possible that in certain embodiments the advancing of the piston could be controlled purely by mechanical means, e.g., a lever and gear assembly that is manually actuated, with an actuation lever (not shown) extending from housing 16.

Again referring to FIGS. 1 and 2, within housing 16, which, as noted above, in certain embodiments would house a stepper motor apparatus, there is reciprocably mounted a permanent part 20 of the piston which can retract into and extend from the housing 16 during movement. The piston 18 also includes a removable end piece 22, which is the only part of the piston that contacts liquid from container 14, the significance of which will be explained below. Removable end piece 22 and permanent part 20 removably connect to one another in an end-to-end manner to form a single piston with a joint. End piece 22 is shown in FIGS. 1 and 2 as having a bayonet style connection with a groove 24 formed in the end piece 22 that mates with pin 26 formed on permanent part 20 to provide a detachable connection between end piece 22 and permanent part 20. It should be understood, however, that the removable connection between parts 20 and 22 can be any of a variety of connections, including threads for a screw-type connection, a snap-fit arrangement, quick-disconnect type fittings, etc. A bearing block 28 having an opening 30 supports the piston 18 as it reciprocates.

The piston pump assembly also includes a nozzle assembly 32 having a main cylinder 33 within which the piston 18 reciprocates to draw in or dispense liquid, as explained in detail below. Nozzle assembly 32 is detachably mounted to and supported by support block 34, which is formed with a radial groove 36 which can hold cylinder 33, e.g., by a friction fit or snap-fit engagement. The removable part 22 may have a length sufficiently long such that only the removable part 22 actually contacts the inner surface of cylinder 33.

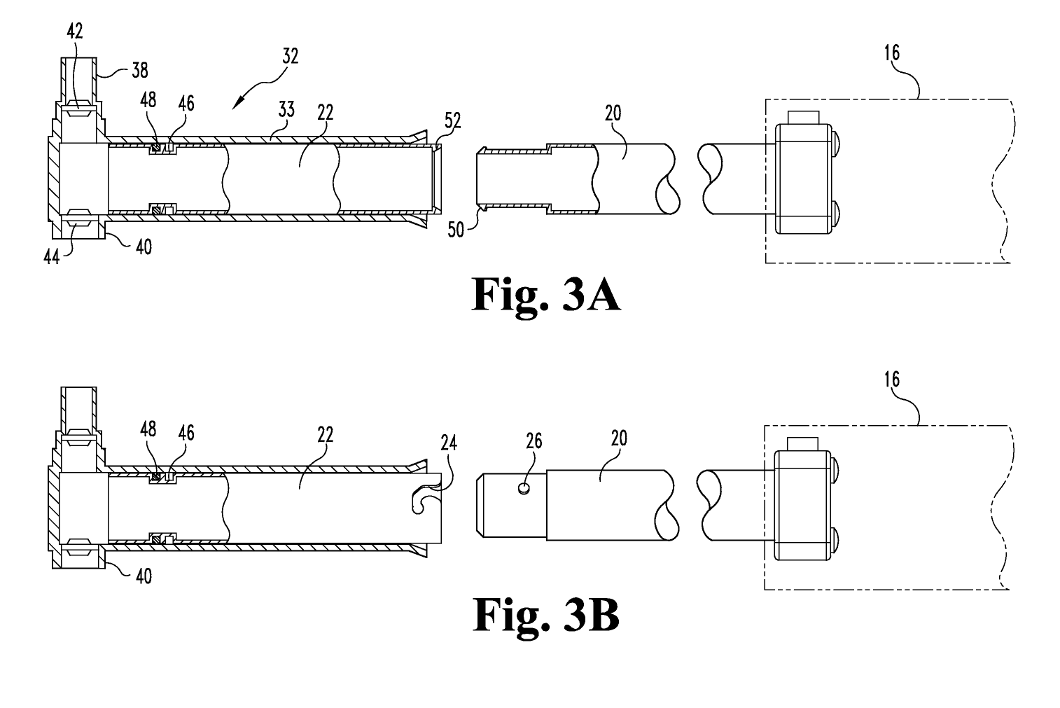

Still referring to FIGS. 1 and 2, and now FIGS. 3A and 3B for greater detail, the nozzle assembly 32 includes an inlet (also referred to as inlet tube) 38 for entry of liquid from container 14 into cylinder 33 and an outlet (as referred to as outlet tube) 40 configured for dispensing a measured amount of liquid, e.g., to a coffee cup. The inlet 38 has a one-way entry valve 42 disposed about the inlet 38 as shown in particular in FIGS. 3A and 3B and is configured to allow liquid from container 14 to enter the cylinder 33 but not exit. Similarly, a one-way exit valve 44 disposed about the outlet 40 is configured to allow liquid to exit the cylinder 33 to be dispensed but not enter.

As shown in FIGS. 3A and 3B, the piston 18, in particular, the removable end piece 22, may include one or more grooves 46 adapted for a seal such as an O-ring 48 as shown. Such a seal prevents liquid from reaching the permanent parts of the piston pump as the piston reciprocates within the main cylinder body 33.

A dispenser in accordance with this disclosure will typically have multiple disposable parts, some of which are intended to be frequently discarded and replaced with new parts. While not necessary, it is desirable to use plastic molded parts for the disposable parts due to their low manufacturing costs. Removable end piece 22, for example, can be provided as a disposable and replaceable part and is thus typically provided as a plastic molded part for the reasons just discussed. It has been found, however, that providing part 22 and nozzle assembly 32 as plastic molded parts presents challenges in terms of tightly controlling the tolerances of the dimensions of the part 22, including the groove 46 and the diameter of piece 22. Additionally, since part 22 reciprocates within cylinder 33, the achievable manufacturing tolerances of both parts make it difficult to provide a consistent seal with O-ring 48 over multiple uses. Even if an adequate seal is obtained at first, the seal may ultimately fail before the liquid supply container is emptied. Further, if a larger O-ring is selected to address the problem of premature failure of the seal, the resultant seal might provide too much friction and thereby require too much power from the motor to reciprocate the piston.

It has been found that a particularly advantageous material for O-ring 48 is ethylene propylene diene monomer (EDPM). More particularly, an EDPM O-ring that has been fluorinated has been found to be particularly suitable. The fluorinated EDPM has a reduced coefficient of friction which allows better reciprocation of the piston while still maintaining a fluid-tight seal over an extended period of dispensation. A process of making a fluorinated elastomer, such as EDPM, is described in U.S. Pat. No. 5,422,404. EDPM O-rings suitable with this disclosure are commercially available from Zatkoff Seals, part no. 2-129 E3609-70 PM, modified by PolyMod Technologies, Fort Wayne, Ind. to decrease the coefficient of friction. Using an O-ring with a reduced coefficient of friction allows oversizing the O-ring to maintain a seal as the piston reciprocates without requiring too much force from the motor to move the piston.

FIGS. 3A and 3B also illustrate two different options for connecting the removable end piece 22 to the permanent part 20 of the piston. FIG. 3A, for example, shows a beveled lip 50 formed in permanent piston part 20 that mates with corresponding lip 52 formed in removable end piece 22, which produces a secure engagement when connected but which allows end piece 22 to be easily removed. FIG. 3B shows in greater detail the bayonet style fitting with pin 26 and groove 24 that was described above with reference to FIGS. 1 and 2. While two specific examples of different connection mechanisms have been just described, it should be understood that other means to provide a removable connection could be used instead, e.g., a threaded connection as noted above.

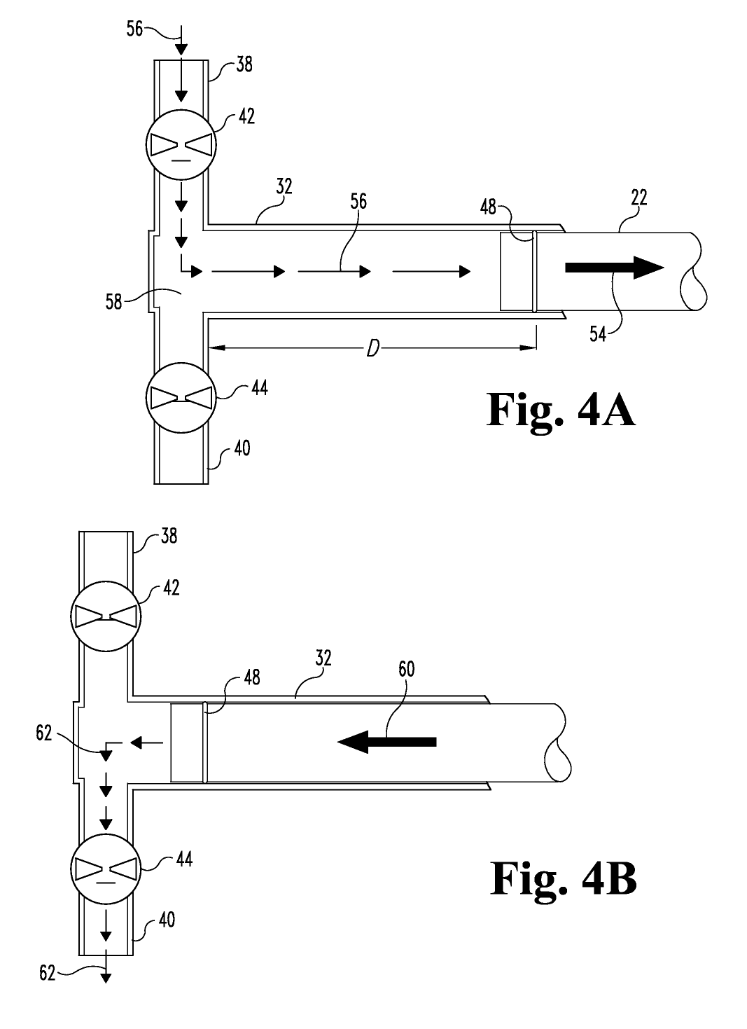

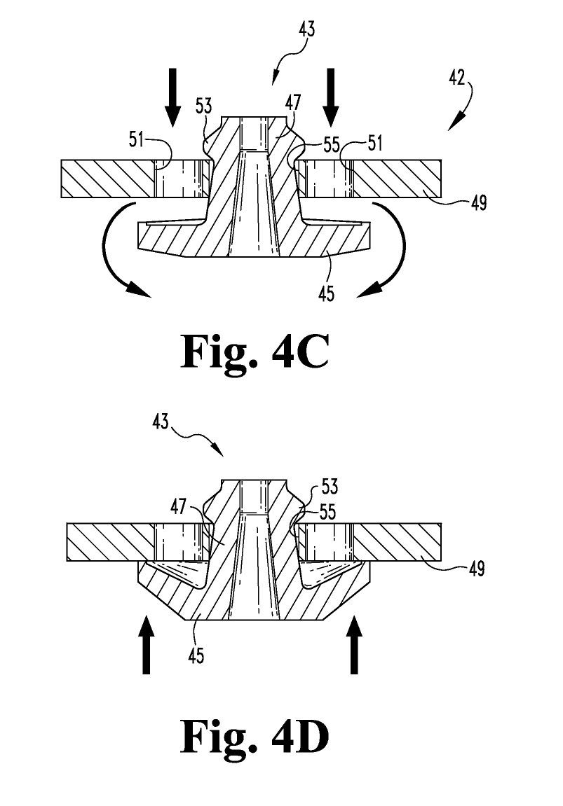

Turning now to FIGS. 4A and 4B, the operation of the inlet, outlet, valves and metering of a dispensed dose can be better understood. As shown in FIG. 4A, the stepper motor is activated to retract piston 18 (end part 22 being shown in FIGS. 4A and 4B) in the direction of arrow 54. In so doing, liquid from container 14 (not shown in FIG. 4A) is drawn into inlet 38 through valve 42 in the direction of arrows 56 to completely fill the cylinder. The diameter of cylinder 33 does not vary along its length and the volume of end space 58 at the end of the cylinder is known. Accordingly, obtaining a predetermined dose volume with great accuracy can be achieved purely as a function of precisely controlling the distance “D,” which in one embodiment is the distance the piston 18 is pushed forward during dispensing. That is, the movement required to achieve a precise volume of liquid to be dispensed is essentially in only one dimension, which simplifies the mechanics and makes it easier to achieve great precision in the measured dose. In some embodiments the precise distance “D” can be the distance of the forward stroke of the piston, in which event the piston may stop short of contacting the end of the cylinder wall. In other embodiments the distance “D” can be configured as a precise retraction distance, in which event the piston would move all of the way to the end of the cylinder during the forward stroke.

With respect to FIG. 4B, once the piston 18 has been retracted, the piston is extended in the direction of arrow 60 a distance D such that the liquid is dispensed as shown by arrows 62 through the valve 44 and from the outlet 40. Since valve 42 only allows fluid to enter the cylinder due to the vacuum created when the piston is retracted, and not vice versa, liquid cannot pass through valve 42 during the dispensing stroke. Similarly, since valve 44 only allows fluid to exit the cylinder due to the positive pressure created when the piston is extended, and not vice versa, liquid cannot pass through valve 42 during the dispensing stroke of the piston. One of skill in the art can readily appreciate, incidentally, that two or more strokes of piston 18 can also be employed to dispense larger doses. Further, the stepper motor or other apparatus that controls the movement of the piston can include a control unit and associated software to allow the amount of the dose, and in turn, the distance D, to be adjusted, e.g., by entering the dose size on a key pad or by providing a dial that can be adjusted to obtain the desired dose.

It should be understood that the piston can be reciprocated multiple times for a single metered dose. That is, if a particularly large dose is required, multiple retractions and extensions of the piston are possible. In such event a visual means such as red and green lights or an audible signal, for example, can be provided to alert the operator of the dispensing apparatus as to when the dispensation is complete.

As described in more detail below, a dispenser in accordance with this disclosure can be used with creams from multiple different containers as well as to dispense different liquids. In this connection, it has been found that the opening pressure of the exit and entry valves is a design variable that may need to be adjusted to achieve the ability to dose the same liquid from differently configured liquid container reservoirs and the ability to dose different liquids. In the context of this disclosure, “opening pressure” can be understood as the net amount of pressure required to be exerted on one of the valves to open it. For valve 42, for example, the opening pressure is a combination of the head pressure exerted by the liquid in the supply container 14 and the suction pressure created within the cylinder by the retraction movement of the piston. Opening pressure can also be a function of the diameter of the inlet tube 38 or any other connecting tubes located between valve 42 and the outlet of the liquid supply container to which the dispenser is connected.

Turning now to FIGS. 4C and 4D, it has been found that an umbrella valve is suitable for use with dispensers in accordance with this disclosure. As shown, inlet valve 42 is provided in the form of an umbrella valve 43. Umbrella valve 43 is an elastomeric valve that has a diaphragm shaped sealing disk 45 (i.e., “umbrella shape”) and a stem 47. Valve 43 is mounted in a valve seat 49 which has multiple openings 51. The valve seat is provided within the inlet 38 and can, e.g., be molded with the remainder of nozzle assembly 32. The valve 43 can be installed into the nozzle assembly 32 after the latter is molded. The stem 47 of valve 43 has a protrusion 53 to secure the valve 43 within opening 55 provided in valve seat 49. In use, the convex sealing disk 45 flattens out against the valve seat 49 and may absorb some irregularities in valve seat 49 to thereby create a sealing force. The umbrella valve will open once the combination of any head pressure and suction pressure create a sufficient net opening pressure. As this happens, the convex disk 45 is lifted from the seat and allows flow of liquid to enter the cylinder 33. FIG. 4C shows valve 43 open such that fluid flow is in the direction of the arrows, through openings 51 formed in the valve seat 49 and then around the disk 45. Below the opening pressure, valve 43 is closed with the disk 45 exerting a force on the valve seat 49 in the direction of the arrows shown in FIG. 4D so that no fluid flow through the inlet 38 is possible. A similar umbrella valve may also be provided in outlet tube 40. The opening pressure required for the valve in the outlet tube 40 will also be determined as a function of head pressure, outlet diameter, type of fluid, etc.

As noted above, it is desirable, depending upon the application, to evaluate the opening pressure needed for one or both valves. If an umbrella valve is employed, one means to adjust the opening pressure with a given valve is to adjust the thickness of valve seat 49. A thicker valve seat will require a higher opening pressure since the thicker valve seat will create more tension on the stem of the umbrella valve and thus pull it tighter. It is also possible to use a different size or material for the valve itself, maintaining the thickness of the valve seat the same.

While umbrella valves are suitable with dispensers in accordance with this disclosure, it should be understood that various other types of valves can be employed. For example, for very high viscosity applications, an electrically controlled solenoid valve could be employed. A solenoid valve would allow the timing of the opening and closing of both valves to matched with the movement of the piston via an electronic control.

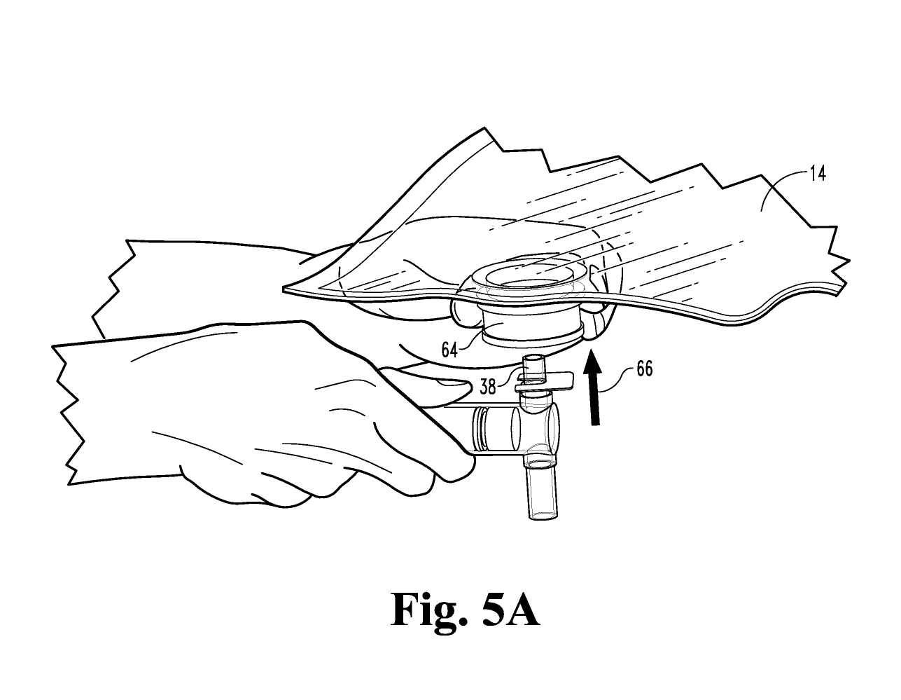

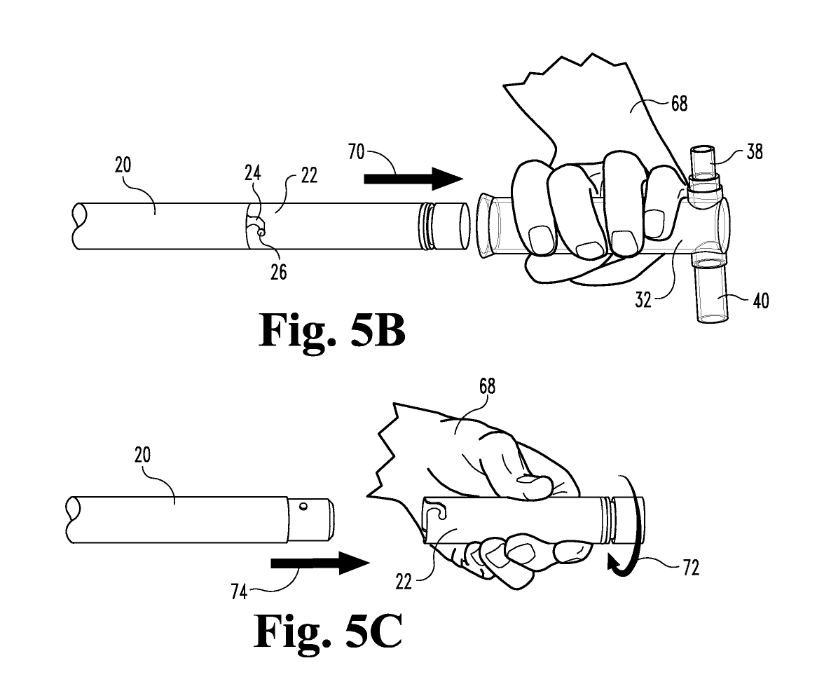

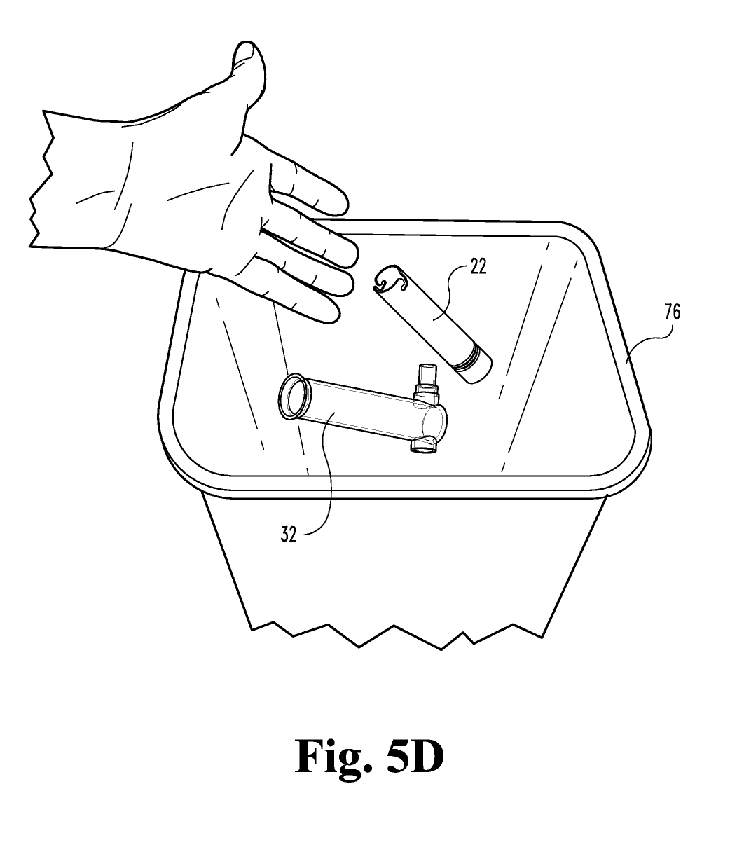

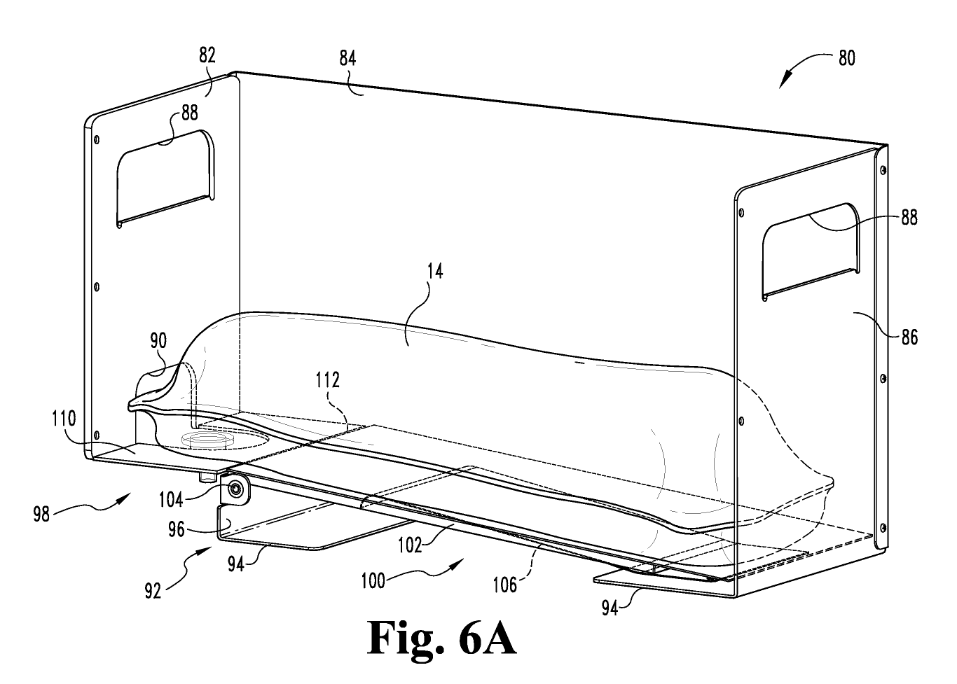

Turning now to FIGS. 5A-5D, the method of switching from a substantially empty container to a new container 14 with a fresh supply of liquid can be appreciated. During use, the piston is reciprocated to dispense one measured dose at a time. Advantageously, since in certain embodiments the container is collapsible and a vacuum is drawn therein, substantially all of the liquid can be withdrawn and used, leaving little or no waste. Further, the vacuum that is drawn on container 14 will serve to collapse the container, making it much smaller and easier to dispose of, as noted elsewhere. In any event, once the liquid from container 14 is depleted, the container must be disconnected. As discussed below, in some cases the container 14 may be disconnected before it is emptied, such as if it is desired to switch to a different liquid to be dispensed. In any event, FIG. 5A shows the disconnection of container 14. The opening 64 of container 14 is simply pulled upward from the inlet 38 and the container can then be discarded. As noted above, the apparatus 10 can be configured to mate with containers 14 having standardized connectors that are intended to be used in a wide variety of dispenser types and models.

FIG. 5B shows a next step in which the nozzle assembly 32 can be pulled from replaceable piston end part 22. As shown, a user's hand 68 can dislodge the cylinder from support 34 while pulling the cylinder from end part 22 in the direction of arrow 70. Next, as depicted in FIG. 5C, the replaceable end part 22 of the piston can be disconnected from permanent part 20 by twisting it in the direction of arrow 72 and pulling it away from part 20 in the direction of arrow 74. In this manner, in certain embodiments, the piston part 22 and nozzle assembly 32 can be discarded in waste receptacle 76 as shown in FIG. 5D, to be replaced with new ones. The assembly of the new parts and new container 14 with fresh supply of liquid can essentially follow the reverse order of disassembly just described.

In other exemplary embodiments, the parts 32 and 22 would not be discarded as shown in FIG. 5D, but they could instead be cleaned and then reused. As another optional embodiment of the inventive method, it is possible to provide new parts 22 and 32 together as a kit, e.g., in new packaging to be used every time a new container 14 is attached to the dispensing unit. It is thus possible that the parts 22 and 32 can be installed to the permanent parts of the dispenser as a single unit and can also be removed as a single unit. This of course saves time in disposal, assembly, disassembly and allows the parts that contact the liquid to be quickly thrown away and replaced with new ones, thereby minimizing the down time between switching from an empty container 14 to a fresh one.

As discussed above, one structural element that is prone to wear out earlier than the others and need replacing is O-ring 48. In a variant of the method of assembly/disassembly just described, the O-ring can be removed, the part 22 cleaned, and then a new O-ring fitted on part 22 before re-connecting part 22 to permanent part 20. However, it may be easier in many situations, especially where speed of exchanging liquid supply containers is critical, to simply dispose of the entire part 22, including the O-ring, and replace part 22 with a new one, including a new O-ring. It is thus advantageous to configure the dispenser with the O-ring on disposable part 22 since, as noted above, the O-ring will likely need to be frequently replaced.

It was also noted above that the dispenser in accordance with this disclosure might be used for multiple liquids. As one of skill in the art will readily appreciate, different liquids have different fluid properties, such as viscosity, surface tension, adhesion to the walls of the container and transport tubes. For example, some substances are stickier than others. Some liquids are emulsions (e.g., cream) while others are suspensions (e.g., ketchup and mustard), which can also affect flow properties. Depending upon the particular properties of the liquid (or semi-liquid) to be dispensed, the opening pressure of one or both of valves 42 and 44 must be considered and selected.

Further, the inlet tube 38 and outlet tube 40 diameters and length also are considered as a function of the particular fluid being dispensed and the particular containers in which it is commercially available. For example, it may be the case that a particular cream is commercially available in 10 liter supply containers having outlet tubes of ¼ inch inside diameter. In such event, it would be desirable to provide a nozzle assembly 32 having an inlet tube 38 with a matching outside or inside diameter to fit the outlet tube of the supply container over or into inlet tube 38 with a tight connection. Similarly, depending upon the type of liquid being dispensed, the length and diameter of the outlet tube 40 might also be evaluated and selected. It has been found that the diameter of the inlet and outlet, in addition to the properties of the particular liquid being dispensed, may affect the requisite opening pressure of the valve 42 and/or valve 44. For example, a smaller diameter inlet 38 may require a valve with a lower opening pressure, all other variables being equal.

Dispensers in accordance with these teachings can be provided with two or more interchangeable nozzle assemblies 32 that can be alternately used with the dispenser. Each nozzle assembly can be configured for a particular liquid to be dispensed and can be configured to mate with a particular supply container in which the liquid is commercially available. Each interchangeable nozzle assembly will have a main cylinder portion in which the piston reciprocates and an inlet tube 38 and an outlet tube 40 fluidly connected to the main cylinder. The inlet tube will have a built-in entry valve 42 configured to allow liquid to enter the cylinder but not exit, and the outlet tube 40 will have a built in exit valve 44 configured to allow liquid to exit the cylinder but not enter. The two or more interchangeable nozzle assemblies may differ from one another in at least one of the following parameters: opening pressure of at least one of the valves, size of the inlet tube, and/or connection fitting of the inlet tube. These parameters are evaluated and implemented into the nozzle assemblies 32 as a function of the properties of the particular liquid to be dispensed and the properties of the fittings and connections of the supply containers in which the liquid is provided.

Advantageously, the parts of the nozzle assemblies that are different from one another, such as valves and inlets and outlets, are provided as part of the nozzle assemblies, typically as a single piece. This ensures a quick and effective modular end use ability for dispensers in accordance with these teachings. For example, if it is desired to repurpose a dispenser from dispensing cream in the morning to dispensing a smoothie-type liquid in the afternoon, the user need simply disconnect the nozzle 32 as described above and replace the removable piston end piece 22 and O-ring with a new one. A new nozzle assembly 32 that is adapted for the new liquid can be installed and connected to the new liquid supply container. Since only a one-piece nozzle assembly and removable part 22 are replaced, rather than separately replacing sub-parts such as valves or inlet or outlet tubes, the conversion of the inventive dispenser from one liquid to another requires little training or understanding to accomplish. The user need simply select which particular nozzle assemblies to use with a particular liquid to be dispensed. Color coding of the nozzle assemblies or other markings can be used to allow the user to easily distinguish the different nozzle assemblies. Similarly, if the new removable part 22 is different for use with the new liquid, it, too, can be color coded or otherwise marked to ensure that the correct item is installed. The electronics and software associated with the dispenser can be configured to allow the user to enter the specific liquid that is being dispensed and select the dose size.

Yet another advantage of switching to a different liquid in accordance with this disclosure is that the nozzle assemblies and removable parts 22 can be configured as disposable. Thus, the nozzle assembly for use with the first liquid can be quickly discarded and the new nozzle assembly can be quickly connected as described above, as a single piece. Similarly, the removable piece 22 can be seamlessly replaced with a new one, either an identical removable piece or a different one adapted for the new nozzle assembly 32. Since there is no cleaning required and a replacement of only a minimum of parts, the switch from one liquid to another can be quick.

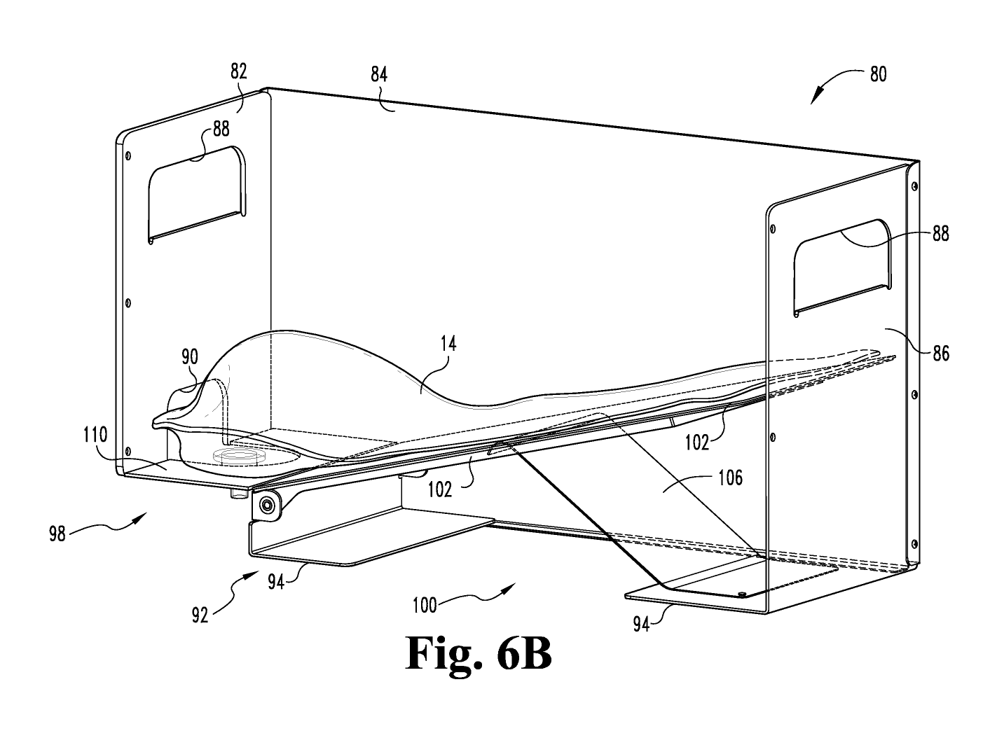

Another feature of this disclosure can be appreciated with reference to FIGS. 6A and 6B, which illustrate a housing 80 or “caddy” that is used to transport supply containers of liquid and house the containers as they are used with the dispenser. (The terms “caddy” and “housing” are used interchangeably herein.) In general, the liquid dispenser according to these teachings will have a frame and a piston pump assembly connected to the frame, as described above. In embodiments having the caddy feature, a housing that is removably mountable to the frame is provided. The housing is particularly adapted to house a flexible and/or collapsible container from which liquid is to be dispensed. The housing 80 can be removably connected to the frame of the dispenser, e.g., by clips or any of a wide variety of connections.

As shown in FIG. 6A, the housing 80 has three sidewalls 82, 84 and 86 that can be formed from e.g., sheet metal. Of course, a wide variety of materials are suitable for the sidewalls. For purposes of illustration, housing 80 is shown without a front sidewall in FIGS. 6A and 6B, but in an exemplary embodiment for use, a front side wall is also typically provided to better house the liquid supply container 14 shown in FIG. 6A. It should also be understood that the caddy 80 is illustrated as rectangular but other shapes can also be employed in accordance with this disclosure. The caddy 80 also has two cut-outs 88 in the shape of handles to allow the caddy to be easily transported. The housing 80 also is formed with an opening 90 through which the dispense fitting or nozzle of the liquid container can be accessed. At least one side of the floor of the housing 80 is elevated from the structure of the dispenser on which it is mounted by means of a base 92. Base 92 in the embodiment illustrated in FIGS. 6A and 6B has two feet 94 and on the left side has a leg 96 that elevates the floor panel 110 of the housing 80. As shown in FIG. 6A, the bottom structure of the housing 80 provides an access area 98 under the opening and an additional access area 100 under the floor.

Housing 80 includes a movable floor panel 102 adapted to support the supply container 14. With reference to FIGS. 6A and 6B, the movable floor panel 102 is pivotable about pivot connection 104 between a first position (FIG. 6A) at which the movable floor panel 102 is positioned at a decline with respect to horizontal and a second position (FIG. 6B) at which the movable floor panel is positioned at an incline with respect to horizontal. As noted above, for purposes of this specification, the term “horizontal” is used to describe a general rather than exact orientation. In this case, the term “horizontal” is used to generally describe the orientation of the floor when it is level with respect to the remainder of the housing 80.

As shown, a leaf spring 106 is mounted to foot 94 on one end and is slidably connected to the movable floor panel 102 at its other end. The end of spring 106 that contacts the underside of panel 102 is curved as shown to facilitate sliding without significant friction or abrasion. The spring 106 biases the movable floor panel toward the second position. More particularly, the spring has a spring force adapted to cause the movable floor panel to pivot toward the second position as the container becomes lighter from liquid being dispensed. While spring 106 in the illustrated embodiment is formed as a leaf spring, one of skill in the art would readily recognize other configurations, such as a coil spring, elastic bands, cylinders, as well as many other spring devices that could alternatively effect the desired spring action of floor 102.

In the illustrated embodiment, the fixed panel 110 is oriented horizontally and positioned adjacent the movable floor panel. The fixed floor panel 110 defines part of the opening 90 and also elevates the dispensing area of the housing vertically from the frame or body of the dispenser, thereby providing access space 98 to connect the liquid container to the inlet of the cylinder of the dispenser. As shown, the fixed floor panel and movable floor panel have adjacent edges which from a joint 112, the joint being located between the two opposite sides walls 82 and 86 of the housing. The movable panel is connected by a pin shown at reference numeral 104, which also denoted the pivot axis. Thus, the pivot axis of the movable floor panel is positioned at the joint 112. One end of the floor panel 102 is thus located at the joint 112 and the opposite end of the floor panel is located at the side wall 86 as shown.

As can be appreciated with a comparison of FIGS. 6A and 6B, during use of the dispenser, as the liquid supply container 14 is depleted, it becomes lighter and the floor panel 102 gradually pivots upwardly as a result. In turn, this causes the liquid remaining in the container to collect toward the portion of the container overlying the fixed panel 110, i.e., over the opening 90 as can be seen in FIG. 6B. While the piston pump assembly gradually draws a vacuum on the supply container and collapses it as the dispenser is used, if the container remains on a level surface as it is emptied, trapped pockets of liquid undesirably develop. By providing a pivoting floor as illustrated, unwanted pockets of trapped liquid remaining in the dispenser are minimized.

Further, the arrangement shown in FIGS. 6A and 6B involves initially providing the pivotable floor on a declined slope. This has the advantage of elevating the fixed floor panel 110 and thus providing a space 98 under panel 110 for access to the opening 90. The arrangement also maximizes the available space provided by the housing 80 for a given supply container; i.e., providing the declined floor panel provides extra room for a full or oversized supply container while allowing the size of the housing 80 to be minimized.

While exemplary embodiments incorporating the principles of this disclosure have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A liquid dispenser, comprising:
a nozzle assembly having a main cylinder body and an inlet and an outlet fluidly connected to and extending from the main cylinder body, the inlet having an entry valve configured to allow liquid to enter the main cylinder body but not exit, and the outlet having an exit valve configured to allow liquid to exit the main cylinder body but not enter; and
a piston reciprocably disposed in the main cylinder body, the piston comprising a permanent part and an end piece removably connectable thereto, the end piece configured to contact the liquid during movement of the piston in the main cylinder body.

2. The liquid dispenser of claim 1, wherein the removable end piece comprises a snap fit connector configured for connection to the permanent part of the piston.

3. The liquid dispenser of claim 1, wherein the removable end piece comprises a bayonet fitting configured for connection to the permanent part of the piston.

4. The liquid dispenser of claim 1, wherein the nozzle assembly is removable from the dispenser.

5. The dispenser of claim 1, wherein the end piece comprises an O-ring that forms a seal between the piston and main cylinder body as the piston reciprocates.

6. The dispenser of claim 5, wherein the O-ring comprises a fluorinated elastomer.

7. The dispenser of claim 6, wherein the elastomer is formed from fluorinated EDPM.

8. The dispenser of claim 1, wherein the inlet and outlet each comprise tubes extending laterally from the main cylinder body.

9. The dispenser of claim 1, wherein the entry valve and the exit valve have different opening pressures.

10. The dispenser of claim 9, wherein the exit valve has a higher opening pressure than the entry valve.

11. The dispenser of claim 1, wherein the entry and exit valves comprise umbrella valves.

12. The dispenser of claim 1, wherein the main cylinder body, the inlet, and the outlet of the nozzle assembly are formed as a one-piece molded component.

13. The dispenser of claim 1, further comprising a stepper motor operably connected to the piston and configured to reciprocate the piston.

14. The dispenser of claim 1, wherein the nozzle assembly comprises first and second interchangeable nozzle assemblies that can be alternately used with the dispenser, the first and second interchangeable nozzle assemblies differing from each other in at least one of the following parameters: opening pressure of one of the valves, size of the inlet, and/or connection fitting of the inlet.

15. A method of operating a liquid dispensing apparatus of the type having a piston pump and a nozzle assembly, the nozzle assembly having a main cylinder body within which a piston of the piston pump reciprocates and an inlet tube and an outlet tube fluidly connected to the main cylinder body, the inlet tube having an entry valve configured to allow liquid to enter the main cylinder body but not exit, and the outlet tube having an exit valve configured to allow liquid to exit the main cylinder body but not enter, the method comprising:
(a) connecting a container having a supply of liquid to the inlet tube;
(b) using the piston pump to dispense measured doses of the liquid until the container is substantially empty or until it is desired to change liquid supplies;
(c) disconnecting the container from the dispenser;
(d) connecting a new container to the dispenser; and
after step (c) and before step (d), performing at least one of the following steps:
(i) disconnecting a removable end piece from a permanent part of the piston; and
(ii) replacing the nozzle assembly, the replacement nozzle assembly differing from the one being replaced in at least one of the following parameters: opening pressure of one of the valves, size of the inlet tube, and connection fitting of the inlet tube.

16. The method of claim 15, wherein step (i) is performed and the method further comprises cleaning the end piece and then re-connecting it to the permanent part of the piston.

17. The method of claim 15, wherein step (i) is performed and the method further comprises providing a new end piece and connecting it to the permanent part of the piston.

18. The method of claim 17, wherein the end piece includes an O-ring to provide a seal between the piston and the cylinder during use of the dispenser, the method further comprising providing a new O-ring with the new end piece.

19. The method of claim 15, wherein steps (i) and (ii) are performed.

20. The method of claim 15, further comprising reciprocating the piston with a stepper motor.

21. A liquid dispenser, comprising:
two interchangeable nozzle assemblies that can be alternately used with the dispenser, each nozzle assembly having a main cylinder body and an inlet tube and an outlet tube fluidly connected to and extending from the main cylinder body, the inlet tube having an entry valve configured to allow liquid to enter the main cylinder body but not exit, and the outlet tube having an exit valve configured to allow liquid to exit the main cylinder body but not enter, the two interchangeable nozzle assemblies differing from each other in at least one of the following parameters: opening pressure of one of the valves, size of the inlet tube, and connection fitting of the inlet tube;
a piston reciprocably mountable in the main cylinder body of the nozzle assembly being used with the dispenser; and
a motor operably connected to the piston and configured to reciprocate the piston.

22. The liquid dispenser of claim 21, wherein the piston comprises a permanent part and an end piece removably connectable thereto, the end piece configured to contact the liquid during movement of the piston in the cylinder.

23. The liquid dispenser of claim 22, wherein the end piece comprises an O-ring that forms a seal between the piston and cylinder as the piston reciprocates.

24. The dispenser of claim 23, wherein the O-ring comprises a fluorinated elastomer.

25. The dispenser of claim 21, wherein the motor comprises a stepper motor.

26. A liquid dispenser, comprising:
a frame;
a piston pump assembly connected to the frame;
a housing removably mountable to the frame and adapted to house a flexible container from which liquid is to be dispensed, the housing comprising:
at least one sidewall;
a movable floor panel adapted to support the container of liquid, the movable floor panel being pivotable between a first position at which the movable floor panel is positioned at a decline with respect to horizontal and a second position at which the movable floor panel is positioned at an incline with respect to horizontal; and
a spring connected to the movable floor panel and biasing the movable floor panel toward the second position, the spring having a spring force adapted to allow the movable floor panel to pivot toward the second position as the container becomes lighter from liquid being dispensed.

27. The dispenser of claim 26, wherein the spring comprises a leaf spring.

28. The dispenser of claim 26, wherein the housing comprises a fixed floor panel positioned adjacent the movable floor panel.

29. The dispenser of claim 28 wherein the fixed floor panel is positioned horizontally.

30. The dispenser of claim 28, wherein the housing further comprises a base positioned beneath the fixed and movable floor panels, the fixed floor panel being spaced vertically above the base.

31. The dispenser of claim 30, wherein the base defines an opening at the bottom of the housing.

32. The dispenser of claim 28, wherein the fixed floor panel has an opening adapted to fit an exit nozzle of the container.

33. The dispenser of claim 28, wherein the fixed floor panel and movable floor panel have adjacent edges which from a joint, the joint being located between two opposite sides of the housing, the pivot axis of the movable floor panel being positioned at the joint.

34. The dispenser of claim 33, wherein one end of the floor panel is located at the joint and the opposite end of the floor panel is located at one of the two opposite sides of the housing.
